(19) United States
(12) Patent Application Publication
(10) Pub. No.: US 2021/0117891 A1
(43) Pub. Date: Apr. 22, 2021

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventor: Daiki KANEICHI, Tokyo (JP)

(73) Assignee: TOYOTA JIDOSHA KABUSHIKI KAISHA, Toyota-shi (JP)

(21) Appl. No.: 16/931,607

(22) Filed: Jul. 17, 2020

(30) Foreign Application Priority Data
Oct. 17, 2019 (JP) 2019-190423

(51) Int. Cl. G06Q 10/06; G06F 16/2457; G06Q 50/30; G06Q 30/06; G06Q 30/02; G06N 20/00; G06N 5/04

(52) U.S. Cl. CPC G06Q 10/06315; G06F 16/24575; G06Q 50/30; G06N 5/04; G06Q 30/0202; G06N 20/00; G06Q 30/0645

(57) ABSTRACT

An information processing apparatus that generates a deployment plan of a shared vehicle to be rented out to a user, includes: a storage section that stores demographic data including one or more attributes, on an area where a station is located at which the shared vehicle is deployed, and a user model in which each attribute included in the demographic data and a tendency to select the shared vehicle are associated with each other; and a control section that determines a vehicle that is deployed at the station, based on the demographic data and the user model.

### CROSS-REFERENCE TO RELATED APPLICATION

This application claims priority to Japanese Patent Application No. 2019-190423 filed on Oct. 17, 2019, incorporated herein by reference in its entirety.

### BACKGROUND

### 1. Technical Field

The disclosure relates to a technique for generating a deployment plan of a shared vehicle.

### 2. Description of Related Art

Vehicle utilization efficiency can be increased by sharing one vehicle among a plurality of users. One of such modes is a car sharing mode in which a vehicle can be rented out on a short-time-period basis (for example, for every 15 minutes).

In car sharing business, it is required that vehicles be deployed in a place where mobility is much in demand. For a related technique, for example, Japanese Patent Application Publication No. 2018-173977 discloses a control apparatus for deploying a vehicle at an appropriate location.

### SUMMARY

A utilization rate of a shared vehicle changes depending on whether or not a deployed vehicle type is appropriate. For example, it is conceivable that commuter vehicles and cargo vehicles are required in a commercial area, while in a residential area, vehicles that can accommodate a plurality of occupants are required. However, it is not easy to estimate what type of a vehicle is to be deployed at a station to increase a profit.

The disclosure is made in light of the problem, and an object of the disclosure is to appropriately determine a deployment plan of a shared vehicle.

An aspect of the disclosure is an information processing apparatus that generates a deployment plan of a shared vehicle to be rented out to a user.

Specifically, the information processing apparatus includes: a storage section that stores demographic data including one or more attributes, on an area where a station is located at which the shared vehicle is deployed, and a user model in which each attribute included in the demographic data and a tendency to select the shared vehicle are associated with each other; and a control section that determines a vehicle that is deployed at the station, based on the demographic data and the user model.

Another aspect of the disclosure is an information processing method performed by an information processing apparatus that generates a deployment plan of a shared vehicle to be rented out to a user.

Specifically, the information processing method includes: a step of acquiring demographic data including one or more attributes, on an area where a station is located at which the shared vehicle is deployed; a step of acquiring a user model in which each attribute included in the demographic data and a tendency to select the shared vehicle are associated with each other; and a step of determining a vehicle that is deployed at the station, based on the demographic data and the user model.

Still another aspect of the disclosure is a program for causing a computer to execute the information processing method performed by the information processing apparatus, or a computer-readable storage medium storing the program in a non-transitory manner.

According to the disclosure, a deployment plan of a shared vehicle can be appropriately determined.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram of a configuration of an information processing apparatus according to a first embodiment;

FIG. 2 is a diagram for describing a user model in the first embodiment;

FIG. 3 is a diagram for describing a mesh in the first embodiment;

FIG. 4 is an example of demographic data stored in a data storage section;

FIG. 5 is a flowchart of processing performed by the information processing apparatus;

FIG. 6 is an example showing deployment locations of stations;

FIG. 7A is a diagram showing processing performed in step S14 in details;

FIG. 7B is a diagram showing processing performed in step S14 in details;

FIG. 7C is a diagram showing processing performed in step S14 in details;

FIG. 8A is a diagram for describing a user model in a second embodiment;

FIG. 8B is a diagram for describing a user model in a second embodiment; and

FIG. 9 is a diagram for describing processing in a third embodiment.

### DETAILED DESCRIPTION OF EMBODIMENTS

It is a challenge to business operators that provide car sharing services what types of vehicles are to be deployed at stations. For example, since required types of vehicles are different between in a residential area and in a commercial area, appropriate vehicle types need to be chosen to ensure utilization rates and profit margins. Moreover, optimal vehicle types also vary among user groups.

It can be predicted, based on past records of rental of vehicles, what type of vehicle, if deployed at a station, can lead to a higher utilization rate and a higher profit margin. However, to predict demands, conditions serving as premises need to be matched. For example, since a geographical characteristic (what area a target station is in) and a user characteristic (what group a usage is expected from) differ from station to station, accuracy in prediction deteriorates if such conditions are mismatched. In other words, when a station is newly set up, an accurate prediction cannot always be made even if past record data generated at another station is used.

In a present embodiment, an information processing apparatus is provided that generates a deployment plan of a shared vehicle to be rented out to a user, not based on past record data, but based only on statistical data.

The deployment plan of the shared vehicle is data indicating what type (body type, vehicle type, riding capacity, size, and the like) of vehicle is deployed at a target station (that may be one or more).

The information processing apparatus according to the embodiment stores demographic data including one or more attributes, on an area where a station is located at which the shared vehicle is deployed, and a user model in which each attribute included in the demographic data and a tendency to select the shared vehicle are associated with each other.

The demographic data is data indicating a population of each attribute in the area where the station is located. The demographic data may include a plurality of attributes. The attributes are, for example, gender, age group, occupation, race, income, and the like, but may include another one. The demographic data may be data indicating a population of inhabitants, or may be data indicating a daytime population or the like. Note that a size, a shape, and the like of an area where statistics are collected are not limited to specific ones.

The user model is a model in which a tendency to select the shared vehicle, that is, a tendency of a user who rents a vehicle to select what type of vehicle is associated with each attribute (for example, each age group, each occupation, each race, and the like) included in the demographic data.

In the information processing apparatus according to the embodiment, a control section determines a vehicle that is deployed at the station, based on the demographic data and the user model. With such a configuration, an appropriate vehicle can be determined based only on the statistical data.

The user model may be data in which a tendency toward a vehicle type shown when the user having a specific attribute rents the shared vehicle is indicated for each of the plurality of attributes.

Vehicle types are, typically, categories such as saloon, coupe, van, hatchback, SUV, minivan, and commercial vehicle, but may be other categories. For example, categories by size or by riding capacity may be used. Categories by further detailed vehicle type may be used.

The user model may be a model in which each of the one or more attributes included in the demographic data and a likelihood of a vehicle being selected by the user having the attribute are associated with each other by vehicle type.

The user model may be a machine learning model that, when the one or more attributes included in the demographic data and a population or populations of the one or more attributes are input, outputs a likelihood set in which a likelihood of a vehicle being selected is indicated by vehicle type.

The user model may be a machine learning model or may be a mathematical model. The user model may be a table or a database.

The control section may determine that a vehicle of a type with the greatest likelihood output by the user model is deployed at the station.

This is because the greatest likelihood means that the probability is highest that a vehicle of the type is used by a user.

The control section may associate a plurality of unit areas with the station, and determine the vehicle that is deployed at the station by using a plurality of pieces of the demographic data corresponding to the plurality of unit areas, respectively.

The control section may acquire the likelihood set for each of the plurality of unit areas and integrate the likelihood sets.

When a station exists, the station is not always accessed only from a unit area where demographics are collected. Accordingly, a plurality of unit areas from which access to the station is expected are identified, and a plurality of pieces of the demographic data corresponding to the plurality of unit areas are used. Thus, accuracy in estimation can be enhanced.

The control section may relearn the user model, based on past records of rental of the shared vehicle.

When data related to past records of rental of vehicles is accumulated, estimation closer to reality can be performed by relearning the user model by using the data.

### First Embodiment

An information processing apparatus according to a first embodiment is an apparatus that determines a preferred type of a shared vehicle that is newly deployed at a station, based on a user model generated beforehand and demographic data.

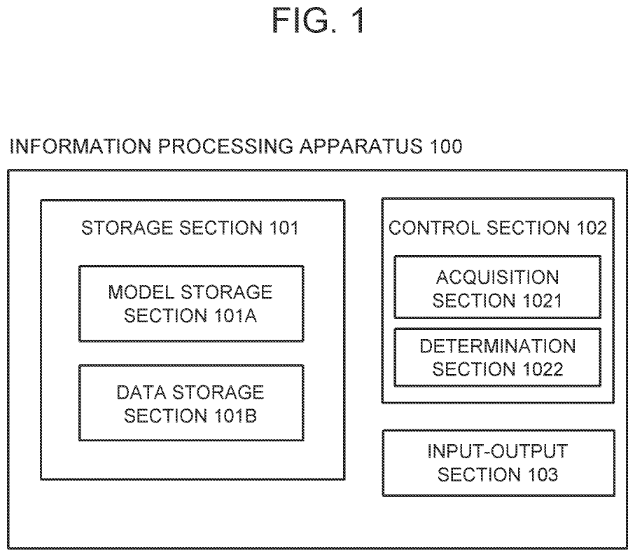

FIG. 1 is a block diagram schematically showing an example of a configuration of this information processing apparatus 100 according to the first embodiment.

The information processing apparatus 100 includes a storage section 101, a control section 102, and an input-output section 103. The information processing apparatus 100 is configured by using a general computer including a processor and a memory.

The storage section 101 is means for storing data required to determine the type of the shared vehicle that is newly deployed at the station. Specifically, the storage section 101 includes a model storage section 101A that stores the user model, and a data storage section 101B that stores the statistical data. Note that the storage section 101 can also store a program to be executed by the control section 102, which will be described later, data to be used by the program, and the like. The storage section 101 is configured by using a storage medium such as a RAM, a magnetic disk, or a flash memory.

The model storage section 101A stores the user model.

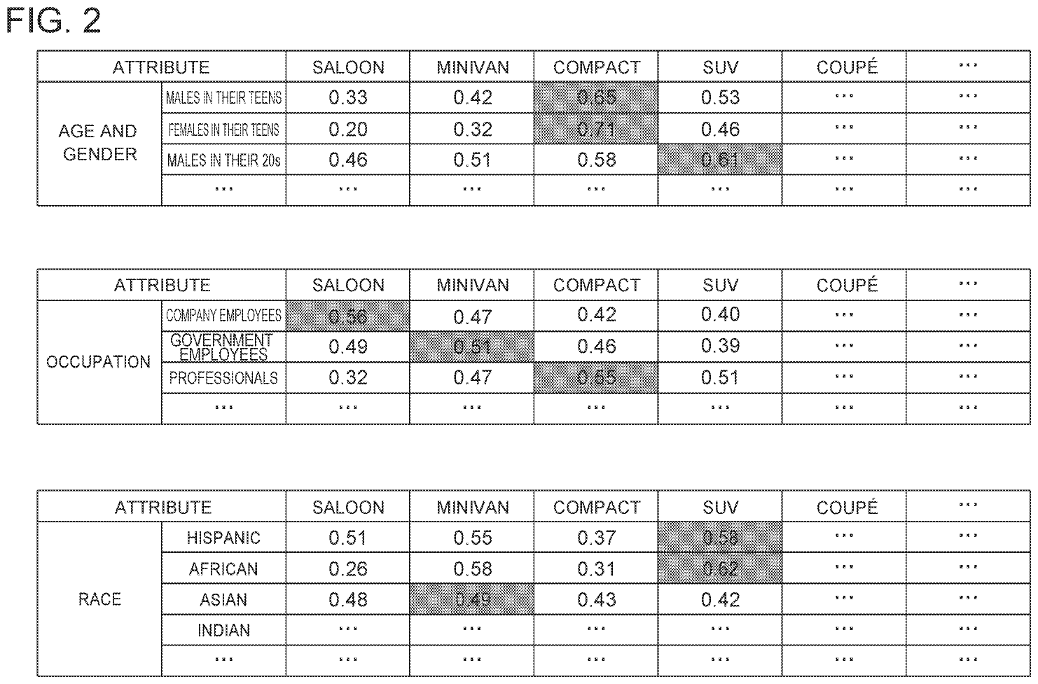

The user model in the first embodiment is a database in which a plurality of attributes included in the demographic data and tendencies of users having such attributes to select what types of shared vehicles (selection tendencies) are associated with each other. FIG. 2 is an example of information associated by the user model. The user model in the embodiment is data indicating correlations between the attributes and the vehicle types in numerical values.

An upper table of FIG. 2 is an example in a case of using age groups and genders of users for an attribute, and a middle table of FIG. 2 is an example in a case of using occupations of users for an attribute. A lower table of FIG. 2 is an example in a case of using races of users for an attribute.

The numerical values in the drawings are dimensionless numbers indicating correlations (hereinafter, correlation values). A higher correlation value indicates a higher probability that the users use vehicles of the type.

The user model can be generated based on data indicating past records of usage of a car sharing service by users (hereinafter, past record data). For example, the user model may be constructed based on the past record data collected by user attribute. The user model may be generated by an external apparatus (for example, a server apparatus managing the whole car sharing service) independent of the information processing apparatus 100 according to the embodiment and acquired via a network or a storage medium.

The data storage section 101B is a database storing the demographic data on each area where a station is located. The database is constructed in such a manner that a program for a database management system (DBMS) to be executed by a processor manages data stored in a storage apparatus. The databases used in the embodiment are, for example, relational databases.

The demographic data may also be generated by an external apparatus (for example, the server apparatus managing the whole car sharing service) independent of the information processing apparatus 100 according to the embodiment and acquired via the network or a storage medium.

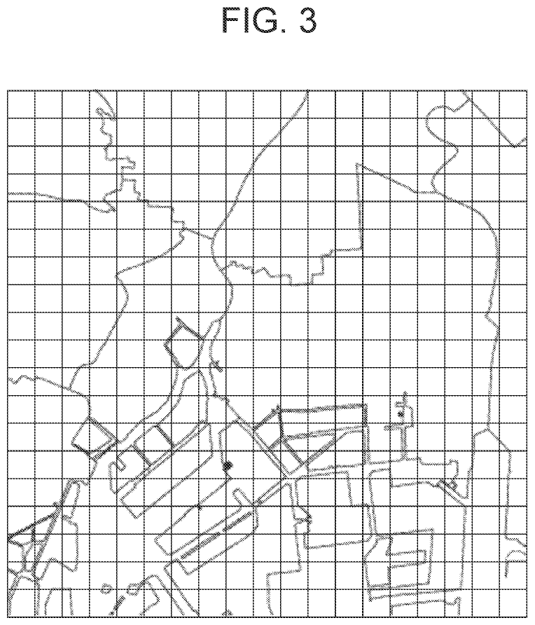

In the embodiment, the demographic data is stored for each mesh, as shown in FIG. 3. In the depicted example, each mesh is a 250 meters by 250 meters square, but the meshes may have other sizes or other shapes. For example, the meshes may be formed in accordance with administrative divisions such as cities, towns, and villages, or sub-areas within cities, towns, and villages.

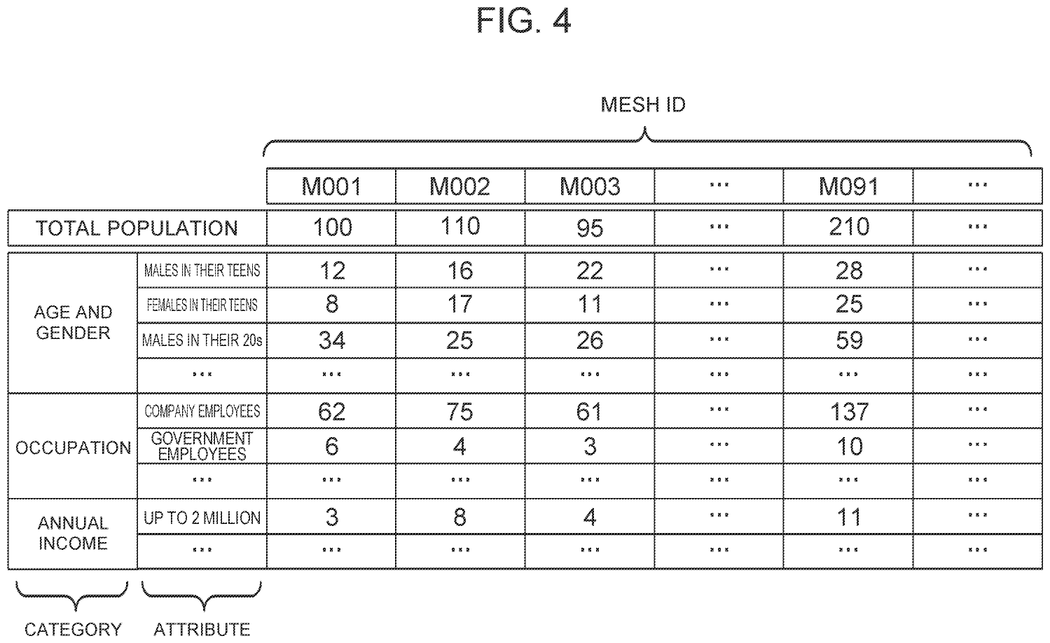

The demographic data is data indicating the number of people existing in each mesh, for each of the plurality of attributes such as age group, gender, occupation, race, and income. FIG. 4 is an example of the demographic data stored in the data storage section 101B. In the example, the plurality of attributes and the respective numbers of users having such attributes in each mesh (that is, the numbers of users existing in each mesh) are recorded. The demographic data is acquired from a data source outside the apparatus. The source of acquisition is not particularly limited.

Although the demographic data is, typically, data indicating the number of people inhabiting a corresponding mesh, a user does not necessarily need to be an inhabitant if there is any possibility that the user uses a shared vehicle.

For example, the real-time number of anonymized people generated based on information transmitted from smartphones may be used.

The control section 102 is a computing unit that controls functions included in the information processing apparatus 100. The control section 102 can be implemented by using a processing unit such as a CPU (Central Processing Unit).

The control section 102 includes functional modules, namely, an acquisition section 1021 and a determination section 1022. Each functional module may be implemented in such a manner that the CPU executes the program stored in the storage section 101.

The acquisition section 1021 acquires the user model and the demographic data on each mesh from the external apparatus and stores the user model and the demographic data in the storage section 101.

Based on the stored user model and demographic data, the determination section 1022 determines a type of a shared vehicle that is newly deployed at each station.

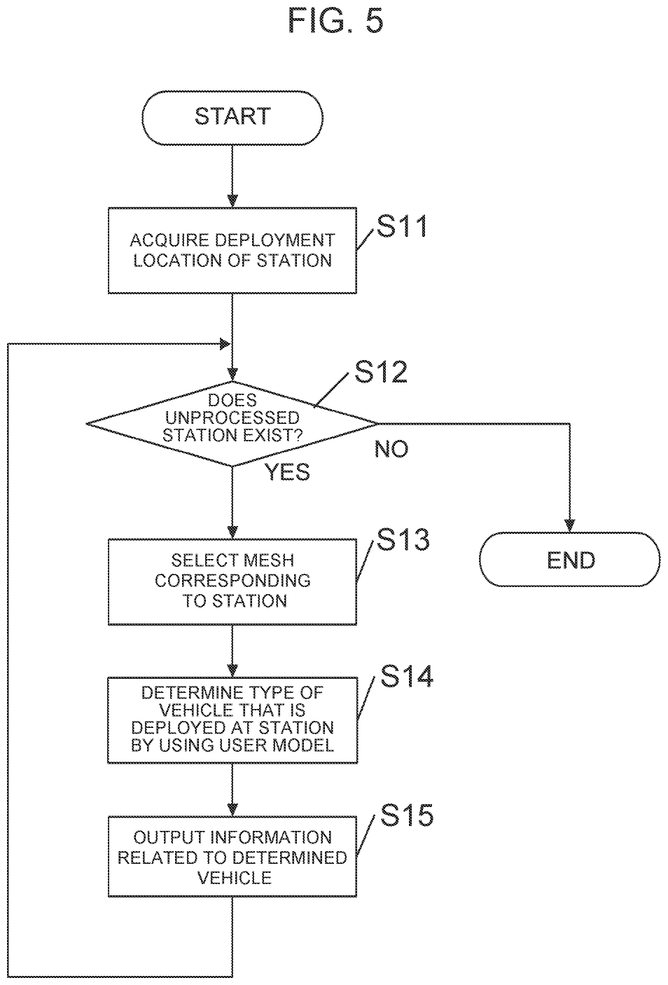

Next, details of processing performed by the determination section 1022 will be described with reference to FIG. 5 that shows a flowchart. Here, it is assumed that the user model is stored in the model storage section 101A. Moreover, it is assumed that the demographic data on a target mesh is stored in the data storage section 101B. In the demographic data, a population of each attribute is recorded for each mesh, as shown in FIG. 4.

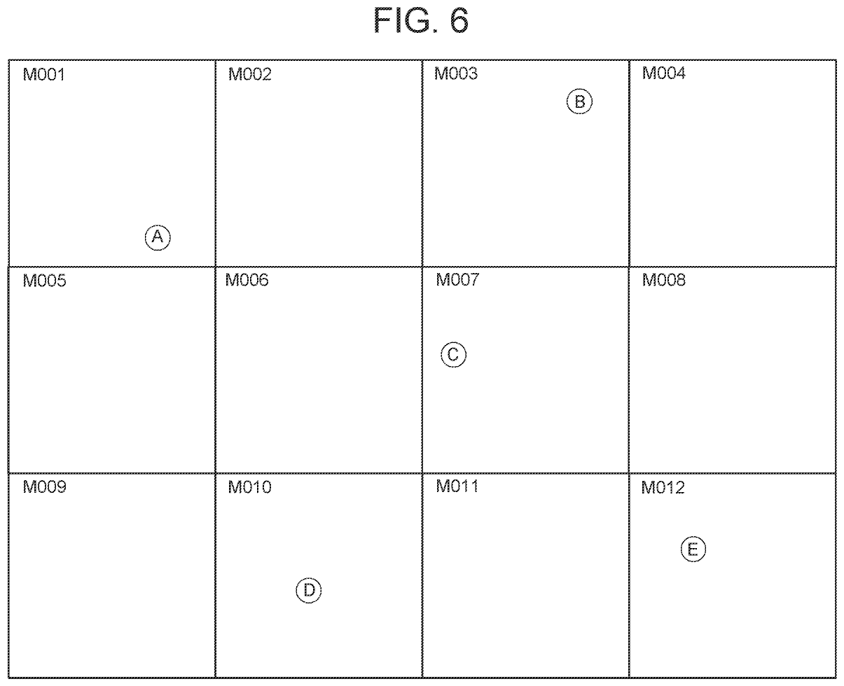

First in step S11, information related to the deployment location of a station at which a vehicle is newly deployed is acquired. The deployment location of a station may be input by a user through the input-output section 103, or may be created by another apparatus and acquired via a network interface or the like. FIG. 6 is an example showing the deployment locations of stations. In the example, it is assumed that five stations are deployed in 12 meshes.

Note that although the statement “a station at which a vehicle is newly deployed” is used in the example, the target station may be a station at which a vehicle is already deployed.

Subsequently in step S12, it is determined whether or not any unprocessed station (a station for which a vehicle type is yet to be determined) exists. Here, when unprocessed stations exist, an unprocessed station is selected as appropriate, and the processing advances to step S13.

In step S13, a mesh corresponding to the processing-target station is selected. For example, in the case of the example shown in FIG. 6, a station A is included in a mesh with an identifier M001. In the case, the mesh with the identifier M001 is selected as a mesh corresponding to the station A. Similarly, when the processing target is a station B, a mesh with an identifier M003 is selected as a corresponding mesh. When the processing targets are stations C, D, E, meshes with identifiers M007, M010, M012 are selected, respectively.

Subsequently in step S14, a type of a vehicle that is deployed in the station (that is, a vehicle type predicted to be most preferred by users in the mesh corresponding to the station) is determined by using the user model.

Here, details of the processing performed in step S14 will be described based on several methods separately.

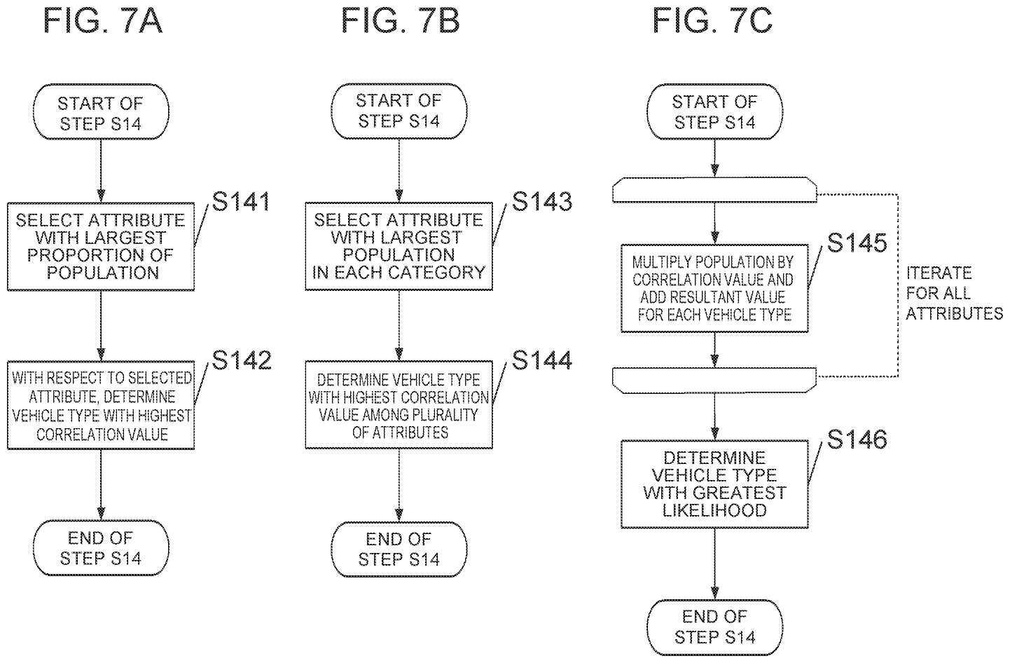

A first method is a method in which a vehicle type is determined by using only one attribute included in the demographic data. FIG. 7A is a flowchart for describing the first method.

First in step S141, among all attributes included in the demographic data, an attribute with the largest proportion to the total population is selected. For example, in the processing-target mesh, it is determined that an attribute with the largest proportion to the total population is “company employees (for example, 62 of 100 people)”.

Subsequently in step S142, with respect to the selected attribute, a vehicle type with the highest correlation value is determined. In the depicted example, a vehicle type “saloon” is determined.

Note that although an attribute with the largest proportion to the total population is selected among all attributes in the present example, a category may be specified first and then an attribute with the largest proportion in the category may be selected. For example, when a category “age and gender” is specified, prediction may be performed by using an attribute “males in their 20s” that has the largest population.

A second method is a method in which an attribute with the largest population is extracted from each of a plurality of categories included in the demographic data, and a vehicle type is determined by using the plurality of attributes extracted. FIG. 7B is a flowchart for describing the second method.

First in step S143, an attribute with the largest population is selected in each category. For example, “males in their 20s” is selected in the category “age and gender”, and “company employees” is selected in a category “occupation”.

Subsequently in step S144, among the plurality of attributes selected, a vehicle type with the highest correlation value is selected. In the case of the present example, “males in their 20s” has a correlation value of 0.61 with SUV, and “company employees” has a correlation value of 0.56 with saloon. In such a case, it is determined that SUV tends to be most rented. In other words, the vehicle type “SUV” is determined.

A third method is a method in which for each vehicle type, a likelihood (a degree at which a vehicle of the type is selected by users) is calculated by using the population of each attribute. Specifically, a value is calculated by multiplying the population of an attribute by the correlation value of each vehicle type associated with the attribute, and the calculated values are added up for each vehicle type. FIG. 7C is a flowchart for describing the third method.

In step S145, for each vehicle type, a value obtained with respect to an attribute by multiplying a population by a correlation value is added. For example, in a certain mesh, when the population of males in their teens is 12 people and the correlation value of males in their teens with compact car is 0.65, a value of 12×0.65=7.8 is added for the type “compact car”. Similarly, when the population of females in their teens is 8 people and the correlation value of females in their teens with compact car is 0.71, a value of 8×0.71=5.68 is added for the type “compact car”.

The processing in step S145 is performed for all attributes and all vehicle types. Thus, a likelihood of each vehicle type can be calculated.

Subsequently in step S146, a vehicle type for which the greatest likelihood is calculated is determined.

Note that although the three methods are illustrated here as methods of determining a vehicle type, another method may be adopted as long as a vehicle type can be determined based on the demographic data.

Through the processing described above, a vehicle type deemed preferred to be deployed is determined for each processing-target station. In step S15, information related to the vehicle recommended to be deployed at each target station is output based on contents of the determination. The results of the processing may be output via the input-output section 103, or may be transmitted to another apparatus connected to the network.

As described above, according to the first embodiment, a type of a vehicle preferred to be deployed at a station can be determined based only on the demographic data. Although various conditions serving as a background need to be matched when estimation is performed by using past records of provision of a car sharing service, according to the embodiment, estimation can be performed with a simple configuration.

Note that in the methods illustrated in the embodiment, a problem arises that when many users with a specific attribute exist, bias in favor of one vehicle type may occur. For example, when a category “race” is included in the user model and when a target area is inhabited mostly (for example, 90% or more) by a specific race, a vehicle type with higher correlation with the race may always be selected. To address such a problem, when an attribute shows bias in a specific category, the category may be excluded from processing targets.

### Second Embodiment

In the first embodiment, a database in which attributes and correlation values are associated is used for a user model. A second embodiment is an embodiment in which a machine learning model learned by using the demographic data and the past record data on the car sharing service is used for a user model.

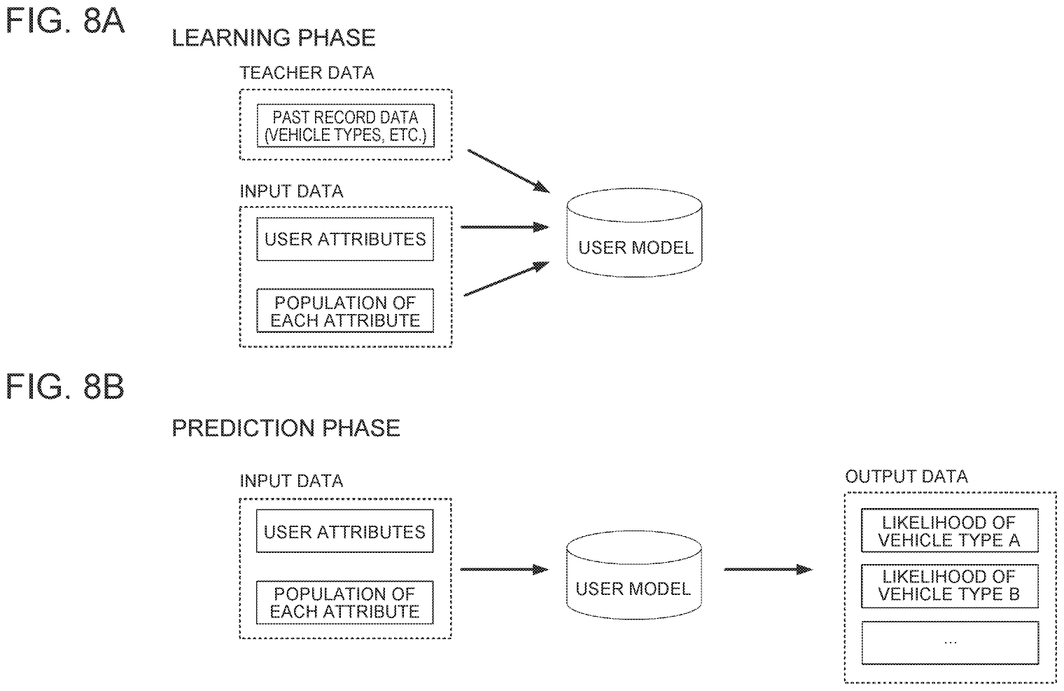

A user model in the second embodiment is shown in FIGS. 8A and 8B. The user model in the second embodiment is a machine learning model constructed by using the demographic data as input data, and using the past record data (data indicating past records obtained when users used car sharing in the past) as teacher data.

The user model in the second embodiment outputs a likelihood of each of a plurality of vehicle types when the demographic data (a set of attributes, and populations of users having the individual attributes) is given as input data.

In the second embodiment, in step S14, the determination section 1022 inputs the demographic data (that is, the plurality of user attributes and the respective populations of the individual attributes) corresponding to a prediction-target mesh into the user model, and acquires a plurality of likelihoods (hereinafter, also referred to as a likelihood set) by vehicle type. Then, a vehicle of a type with the greatest likelihood is determined as a vehicle to be deployed at a station.

As described above, the machine learning model can also be used for a user model.

Note that when the machine learning model is adopted as a user model, after an operation of a car sharing service is started and past record data at a station of interest is generated, relearning of the user model may be performed by using the past record data. According to such a configuration, accuracy in estimation for the station can be enhanced.

### Third Embodiment

Although only the demographic data corresponding to one mesh is used when a type of a vehicle that is deployed at a station is determined in the second embodiment, there are some cases where such a method is not appropriate. An example of such cases is a case where users who use a vehicle deployed at a station are expected to come from a plurality of meshes. In the case, accurate estimation cannot be performed unless the demographic data on the plurality of applicable meshes are considered.

In a third embodiment, a method addressing such a problem will be described.

For a first method, a method is used in which the demographic data on the plurality of meshes is integrated. Specifically, when a certain station is expected to be used from a plurality of meshes, a virtual mesh is generated by summing populations in the plurality of meshes for each attribute. For example, when meshes M001 and M002 are integrated in the example shown in FIG. 4, a virtual mesh indicated as M091 can be generated. Then, the processing shown in step S14 is performed for the virtual mesh as a target mesh. It may be determined as appropriate which meshes are integrated, depending on geographical conditions of the meshes and the like.

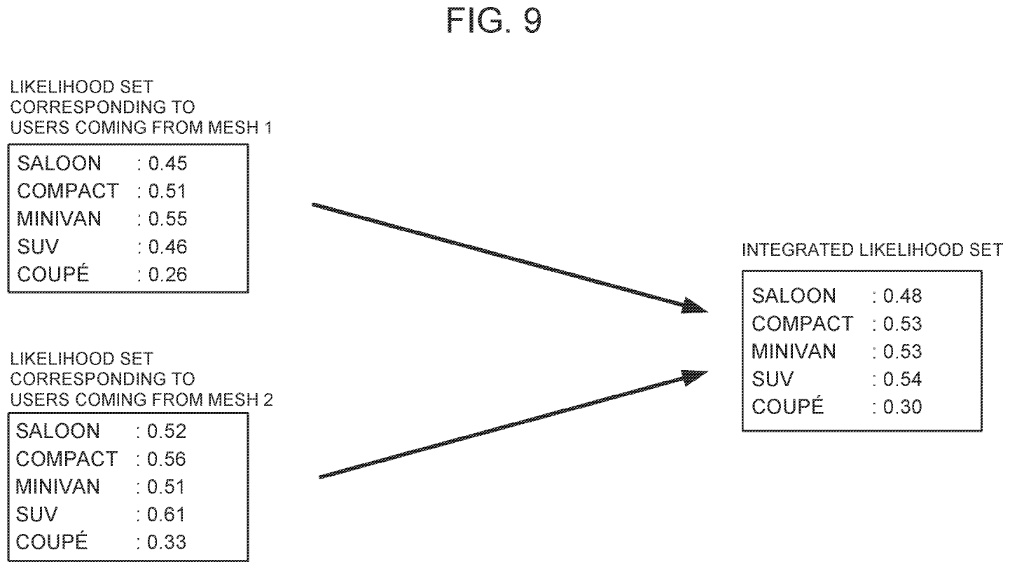

For a second method, a method is used in which a likelihood set is acquired for each mesh and the likelihood sets are integrated. For example, as shown in FIG. 9, after a likelihood set is acquired for each mesh, a representative value (for example, a mean value or the like) of the likelihoods of each vehicle type is computed. Thus, the plurality of likelihood sets are integrated. Then, a vehicle type is determined by using the integrated likelihood set.

Note that when the demographic data or the likelihood sets are integrated, each mesh may be weighted. For example, the probability that a user existing in a certain mesh uses a certain station decreases as the distance between the mesh and the target station becomes longer. Accordingly, a weight may be assigned to each mesh, and the demographic data or the likelihood sets may be multiplied by the weights when integrated. A weight assigned to a mesh can be, for example, a value that is smaller as the mesh is farther away from a target station.

### MODIFICATION EXAMPLES

The embodiments described above are examples in every respect, and the disclosure can be worked by making changes as appropriate without departing from the gist of the disclosure.

For example, the processing and the means described in the disclosure can be freely combined to be performed or implemented to the extent that no technical inconsistency occurs.

Although a vehicle type is determined based only on the demographic data in the description of the embodiments, a vehicle type may be determined, taking into consideration other elements than the demographic data. For example, the likelihoods or the correlation values may be corrected based on a geographic characteristic of a mesh where a station is deployed, or on information related to a building or a facility included in the mesh.

The processing described as being performed by a single apparatus may be performed by a plurality of apparatuses in a divided manner. Alternatively, the processing described as being performed by different apparatuses may be performed by a single apparatus. In a computer system, it can be flexibly changed what hardware component or components (server component or components) are used to implement each function.

The disclosure can also be implemented in such a manner that a computer program packaging the functions described in any of the embodiments is provided to a computer, and one or more processors included in the computer read and execute the program. Such a computer program may be provided to the computer by using a non-transitory computer-readable storage medium that can connect to a system bus of the computer, or may be provided to the computer via a network. Examples of the non-transitory computer-readable storage medium include any types of disks/discs such as magnetic disks (floppy® disk, hard disk drive (HDD), and the like) and optical discs (CD-ROM, DVD disc, Blu-ray Disc, and the like), a read-only memory (ROM), a random-access memory (RAM), an EPROM, an EEPROM, a magnetic card, a flash memory, an optical card, and any types of media suitable to store electronic instructions.

What is claimed is:

1. An information processing apparatus that generates a deployment plan of a shared vehicle to be rented out to a user, comprising:
a storage section that stores demographic data including one or more attributes, on an area where a station is located at which the shared vehicle is deployed, and a user model in which each attribute included in the demographic data and a tendency to select the shared vehicle are associated with each other; and
a control section that determines a vehicle that is deployed at the station, based on the demographic data and the user model.

2. The information processing apparatus according to claim 1, wherein the user model is data in which a tendency toward a vehicle type shown when the user having a specific attribute rents the shared vehicle is indicated for each of a plurality of the attributes.

3. The information processing apparatus according to claim 1, wherein the user model is a model in which each of the one or more attributes included in the demographic data and a likelihood of a vehicle being selected by the user having the attribute are associated with each other by vehicle type.

4. The information processing apparatus according to claim 1, wherein the user model is a machine learning model that, when the one or more attributes included in the demographic data and a population or populations of the one or more attributes are input, outputs a likelihood set in which a likelihood of a vehicle being selected is indicated by vehicle type.

5. The information processing apparatus according to claim 4, wherein the control section determines that a vehicle of a type with a greatest likelihood output by the user model is deployed at the station.

6. The information processing apparatus according to claim 4, wherein the control section associates a plurality of unit areas with the station, and determines the vehicle that is deployed at the station by using a plurality of pieces of the demographic data corresponding to the plurality of unit areas, respectively.

7. The information processing apparatus according to claim 6, wherein the control section acquires the likelihood set for each of the plurality of unit areas and integrates the likelihood sets.

8. The information processing apparatus according to claim 4, wherein the control section relearns the user model, based on past records of rental of the shared vehicle.

9. The information processing apparatus according to claim 1, wherein the one or more attributes included in the demographic data include at least one of age group, gender, occupation, race, and income.

10. An information processing method performed by an information processing apparatus that generates a deployment plan of a shared vehicle to be rented out to a user, comprising:
a step of acquiring demographic data including one or more attributes, on an area where a station is located at which the shared vehicle is deployed;
a step of acquiring a user model in which each attribute included in the demographic data and a tendency to select the shared vehicle are associated with each other; and
a step of determining a vehicle that is deployed at the station, based on the demographic data and the user model.

11. The information processing method according to claim 10, wherein the user model is data in which a tendency toward a vehicle type shown when the user having a specific attribute rents the shared vehicle is indicated for each of a plurality of the attributes.

12. The information processing method according to claim 10, wherein the user model is a model in which each of the one or more attributes included in the demographic data and a likelihood of a vehicle being selected by the user having the attribute are associated with each other by vehicle type.

13. The information processing method according to claim 10, wherein the user model is a machine learning model that, when the one or more attributes included in the demographic data and a population or populations of the one or more attributes are input, outputs a likelihood set in which a likelihood of a vehicle being selected is indicated by vehicle type.

14. The information processing method according to claim 13, wherein it is determined that a vehicle of a type with a greatest likelihood output by the user model is deployed at the station.

15. The information processing method according to claim 13, wherein a plurality of unit areas are associated with the station, and the vehicle that is deployed at the station is determined by using a plurality of pieces of the demographic data corresponding to the plurality of unit areas, respectively.

16. The information processing method according to claim 15, wherein the likelihood set is acquired for each of the plurality of unit areas, and the likelihood sets are integrated.

17. The information processing method according to claim 13, wherein the user model is relearned based on past records of rental of the shared vehicle.

18. The information processing method according to claim 10, wherein the one or more attributes included in the demographic data include at least one of age group, gender, occupation, race, and income.

19. A program for causing a computer to execute the information processing method according to claim 10.
